(19) United States
(12) Patent Application Publication
(10) Pub. No.: US 2025/0371065 A1
(43) Pub. Date: Dec. 4, 2025

(54) ADAPTIVE MISINFORMATION DETECTION

(71) Applicant: Microsoft Technology Licensing, LLC, Redmond, WA (US)

(72) Inventors: MohammadReza GHAEINI, Seattle, WA (US); Lizhen PENG, Kirkland, WA (US); Can LI, Redmond, WA (US)

(21) Appl. No.: 18/680,962

(22) Filed: May 31, 2024

(51) Int. Cl. G06F 16/383; G06F 16/33; G06F 16/332

(52) U.S. Cl. CPC G06F 16/383; G06F 16/332; G06F 16/3344

(57) ABSTRACT

A system may store pieces of misinformation in a retrieval database. The system may receive a request to analyze content for misinformation. The system may retrieve a set of misinformation from the retrieval database, wherein the set of misinformation relates to the content, and wherein the set of misinformation is part of the pieces of misinformation. The system may generate a dynamic prompt based on the set of misinformation, wherein the dynamic prompt includes the set of misinformation. The system may detect a similarity between the content and the set of misinformation by applying the dynamic prompt. The system may conclude that the content includes misinformation in response to detecting the similarity between the content and the set of misinformation.

### BACKGROUND

Users may use search engines and generative AI (artificial intelligence) chats for searching for answers to their questions. Due to the nature of typical search engines, they may only provide various webpages as a result, which have been indexed by web crawlers (also known as web spiders, or web bots), without verifying if the information in these webpages is accurate, true, up-to-date, and reliable. Hence, users are frequently subjected to misinformation, outdated, false, or inaccurate information. Misinformation can also harm society, such as by dividing public debate, weakening democratic principles, provoking violence, or influencing people’s beliefs, decisions, and actions. Deliberately spreading misinformation online with the purpose of misleading others or to advance a specific agenda is a commonly used tactic in digital warfare. Understanding and combating misinformation becomes crucial for everyday users as they try to make informed decisions based on the results they receive.

### BRIEF SUMMARY

In some embodiments, a computer-implemented method for detecting misinformation is provided. The method includes storing pieces of misinformation in a retrieval database. The method further includes receiving a request to analyze content for misinformation. The system further includes retrieving a set of misinformation from the retrieval database; this set of misinformation relates to the content to be analyzed and is part of the pieces of misinformation. The system further includes generating a dynamic prompt based on the set of misinformation; this dynamic prompt includes the set of misinformation. The system further includes detecting a similarity between the content and the set of misinformation by applying the dynamic prompt. The system further includes concluding that the content includes misinformation in response to detecting the similarity between the content and the set of misinformation.

In other embodiments, a computer-implemented method for detecting misinformation is provided. The method includes receiving pieces of misinformation and storing the pieces of misinformation in a retrieval database as misinformation embeddings. The method further includes receiving a request to analyze content for misinformation and encoding the content into one or more content embeddings. The method further includes retrieving a set of misinformation embeddings from the retrieval database; this set of misinformation embeddings relates to the one or more content embeddings and is part of the misinformation embeddings. The method further includes generating a dynamic prompt based on the set of misinformation embeddings; this dynamic prompt includes the set of misinformation embeddings and a framework. The method further includes detecting a similarity between the one or more content embeddings and the set of misinformation embeddings by applying the dynamic prompt. The method further includes concluding that the content includes misinformation in response to detecting the similarity between the one or more content embeddings and the set of misinformation embeddings.

In yet other embodiments, a system is provided. The system includes at least one processor and a non-transitory computer memory comprising instructions that, when executed by the at least one processor, cause the system to perform operations of: (i) storing pieces of misinformation in a retrieval database, (ii) receiving a request to analyze content for misinformation, (iii) retrieving a set of misinformation from the retrieval database, wherein the set of misinformation relates to the content, and wherein the set of misinformation is part of the pieces of misinformation, (iv) generating a dynamic prompt based on the set of misinformation, wherein the dynamic prompt includes the set of misinformation, (v) detecting a similarity between the content and the set of misinformation by applying the dynamic prompt, and (vi) concluding that the content includes misinformation in response to detecting the similarity between the content and the set of misinformation.

In some aspects, the techniques described herein relate to a computer-implemented method for detecting misinformation, including: receiving a request to analyze content for misinformation; retrieving a set of misinformation that relates to the content by analyzing features of the content to identify misinformation with similar features; generating a dynamic prompt that includes the content and the set of misinformation; in response to providing the dynamic prompt to a generative artificial intelligence (AI) model, receiving a similarity score indicating a similarity between the content and the set of misinformation; and based on using the similarity score to determine that the content includes misinformation, providing an indication that the content includes misinformation in response to the request.

In some aspects, the techniques described herein relate to a computer-implemented method for detecting misinformation, including: receiving a request to analyze content for misinformation; encoding the content to one or more content embeddings; retrieving a set of misinformation embeddings that are similar to the one or more content embeddings from a retrieval database; generating a dynamic prompt based on the set of misinformation embeddings that includes the content and instructions on how to determine a similarity score; in response to providing the dynamic prompt to a generative artificial intelligence (AI) model, receiving the similarity score indicating a similarity between the content and the set of misinformation embeddings; and determining that the content includes misinformation based on the similarity score for the content.

In some aspects, the techniques described herein relate to a system including: a processing system having a processor; and a computer memory including instructions that, when executed by the processing system, cause the system to carry out operations including: receiving a request to analyze content for misinformation; retrieving a set of misinformation that relates to the content by analyzing features of the content to identify misinformation with similar features; generating a dynamic prompt that includes the content and the set of misinformation; in response to providing the dynamic prompt to a generative artificial intelligence (AI) model, receiving a similarity score indicating a similarity between the content and the set of misinformation; and based on using the similarity score to determine that the content includes misinformation, providing an indication that the content includes misinformation in response to the request.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 illustrates an adaptive misinformation detection system for identifying misinformation, in accordance with at least one embodiment.

FIG. 2 illustrates an adaptive misinformation detection system for identifying misinformation, in accordance with at least one embodiment.

FIG. 3 illustrates an example of detecting similarity between content and a set of misinformation.

FIG. 4 illustrates an example of detecting similarity between content and a set of misinformation based on a prompt.

FIG. 5 illustrates an example series of acts of a computer-implemented method for detecting misinformation according to one or more embodiments.

FIG. 6 illustrates an example series of acts of a computer-implemented method for detecting misinformation according to one or more embodiments.

FIG. 7 illustrates certain components that may be included within a computer system that implements the adaptive misinformation detection system.

### DETAILED DESCRIPTION

This disclosure generally relates to systems, computer-implemented methods, and devices for filtering content provided to users based on a misinformation dataset. In a traditional system, censorship may be used to filter out all content related to a certain topic. For example, a parent may select to filter out adult content when their children use electronic devices. However, filtering out an entire topic does not work in situations where relevant and/or correct information about the topic is needed, and only one or more pieces of misinformation need to be filtered out.

The features and functionalities described herein provide a number of advantages and benefits over conventional approaches and systems. For example, the systems described herein provide features and functionalities related to detecting misinformation from content, by detecting similarities between the content and a set of misinformation data. It will be appreciated that the advantages and benefits discussed herein are provided by way of example and are not intended to be an exhaustive list of all possible advantages and benefits of implementations of the adaptive misinformation detection functionality.

For example, in some embodiments, only content that has been categorized as misinformation may be removed, hidden, or corrected without the need to censor all content related to a topic. This allows more content to be shared, while only limiting access to content including misinformation. One possible advantage of this embodiment is that the system does not need to censor a whole topic, but only filters out content having misinformation.

Conventionally, a model, such as large language model (LLM), may have been used to analyze if content includes misinformation by providing data on what misinformation is. This approach includes several disadvantages, such as the need to train the model to correctly identify misinformation every time a new piece of misinformation is added to a database. Furthermore, allowing the model to determine if content includes misinformation based on the model’s own understanding of both the content and the misinformation dataset does not provide reliable results. In addition to identifying misinformation in content, the computer-implemented methods described herein provide a fast method for quickly adding new data to a database that can be utilized immediately by the adaptive misinformation detection system. Furthermore, one or more embodiments described herein may provide a model that is relied upon only for its reasoning and/or interference capabilities to identify similarity between a piece of misinformation and the content by providing a framework (e.g., instructions) for a model to analyze the similarity. For example, the model may be provided with a prompt that provides specific instructions to the model on how to determine similarity and/or a similarity score. One possible advantage of limiting what the model does and/or by providing specific instructions for the model is increasing the reliability of the outcome, as the model does not have to make the determination based on its own understanding of the misinformation and/or the content.

Another possible advantage of at least one embodiment of this disclosure is that additional pieces of misinformation can be easily added to the system. After the content has been identified to include misinformation, the misinformation (e.g., the misinformation statement) in the content can be added to the misinformation database to provide additional examples and/or variations. This may allow the misinformation system, in at least one embodiment, to more efficiently find and/or correctly categorize new content as misinformation.

As illustrated in the foregoing discussion, a variety of terms are used to describe features and/or advantages of one or more embodiments of the adaptive misinformation detection system and computer-implemented methods for facilitating detecting misinformation in content. Additional details will now be provided regarding the meaning of some of these terms. Further terms will also be discussed in detail in connection with the description of one or more embodiments and/or specific examples provided below.

As an example, misinformation refers to incorrect or misleading information that may or may not be spread intentionally. Misinformation may result from one or more of misunderstandings, rumors, deliberate efforts to deceive, or combinations thereof. Misinformation may be referred to as one or more pieces or misinformation and/or misinformation data and/or may include one or more misinformation statements and/or one or more misinformation descriptions.

As an example, a hierarchical navigable small world (HNSW) refer to techniques, systems, and/or computer-implemented methods for storing and/or searching information. In some cases, information may be stored and/or searched as vectors. Information vectors can represent data stored in a database in a multi-layer structure that includes one or more hierarchical sets of proximity graphs (e.g., layers). The location of each vector in the graph corresponds to its similarity to other vectors in the graph. For example, two vertices of two vectors may be linked based on their proximity. The closer the two vectors are in the n-dimensional space, the more similar they are. Similarity is typically determined by the distance of the two vectors. One possible benefit of using HNSW for storing and/or retrieving data includes one or more of adding new data, searching similar data by using a query, and locating K nearest neighbors from the HNSW that are closest (e.g., similar or related) to the query in question, or combinations thereof. It is therefore adaptable to quickly add new data to it without the need to train, retrain, or reiterate the entire solution. HNSW is also capable of storing and/or managing a search of a big set of data.

As an example, a vector embedding (or embedding for short) refers to a method for representing objects (e.g., text, images, and audio) and their features as points in a multidimensional space (e.g., a vector space). Vector embeddings are often used in machine learning (ML) and artificial intelligence (AI) techniques to identify latent features of objects, for which different objects can be linked and/or grouped based on sharing similar features. In some instances, vector embeddings may enable models to understand relationships between objects and/or find similarities, even in complex natural language data. Vector embeddings are often numerical representations of concepts converted into number sequences that make it easier for computers to understand relationships between different concepts and features. Some examples of vector-based embeddings are Ada-embeddings (e.g., text-embedding-ada-002) and Bag Of Word embedding (BOW embedding).

As an example, a large language model (LLM) refers to a generative artificial intelligence (AI) model that utilizes natural language processing techniques. A generative pre-trained transformer model (GPT model) is a subset of LLM that is based on transformer architecture. A small language model (SLM) is a compact AI model that uses a smaller neural network, fewer parameters, and less training data. Hence, unlike LLMs with hundreds of billions of parameters, an SLM operates with a more modest capacity. SLM models are designed to achieve meaningful performance while maintaining a smaller scale compared to LLM models.

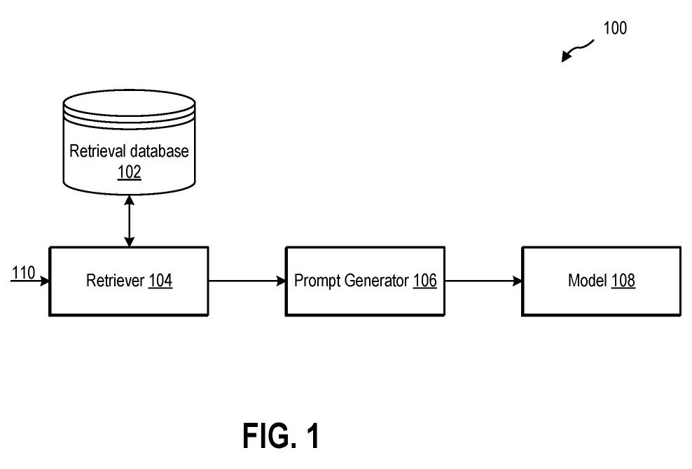

FIG. 1 illustrates an adaptive misinformation detection system 100 for identifying misinformation, in accordance with at least one embodiment. The adaptive misinformation detection system 100 includes a retrieval database 102. In some embodiments, the retrieval database 102 stores pieces of misinformation. For example, “Covid-19 is a hoax” may be a statement that is stored in the retrieval database 102 as a piece of misinformation. In some embodiments, the retrieval database 102 stores pieces of misinformation (e.g., misinformation statements and/or misinformation descriptions). For example, a statement that asserts that “COVID-19 vaccines caused excess deaths among millennials” may be followed by a more detailed description of “U.S. Centers for Disease Control and Prevention (CDC) data shows excess deaths among millennials increased by 84 percent in 2021, coinciding with the rollout of COVID-19 vaccines and booster shots.” In some embodiments, the retrieval database 102 stores and/or retrieves data using a hierarchical navigable small world (HNSW) method. HNSW incrementally builds a multi-layer structure consisting of a hierarchical set of proximity graphs (e.g., layers) for nested subsets of the stored data. In some embodiments, the retrieval database 102 stores and/or retrieves data using hierarchical clustering. Hierarchical clustering may group data points, for example, into a tree-like structure of clusters based on their similarity and/or distance. Typically, a hierarchical clustering solution is a bottom-up solution where each item is a cluster at the bottom and these clusters may be merged on each level. The misinformation (e.g., misinformation data) stored in the retrieval database 102 as embeddings to allow quick and/or easy search of similar data.

The adaptive misinformation detection system 100 further includes a retriever 104. The retriever 104 is configured to receive a request 110 to analyze content for misinformation. In some embodiments, the retriever 104 may retrieve a set of misinformation. For example, the retriever 104 may retrieve a set of misinformation that relates to content in a misinformation request by analyzing features (e.g., embeddings) of the content to identify misinformation in the retrieval database with similar features. The set of misinformation is part of the pieces of misinformation from the retrieval database 102. For example, the set of misinformation may relate to the content.

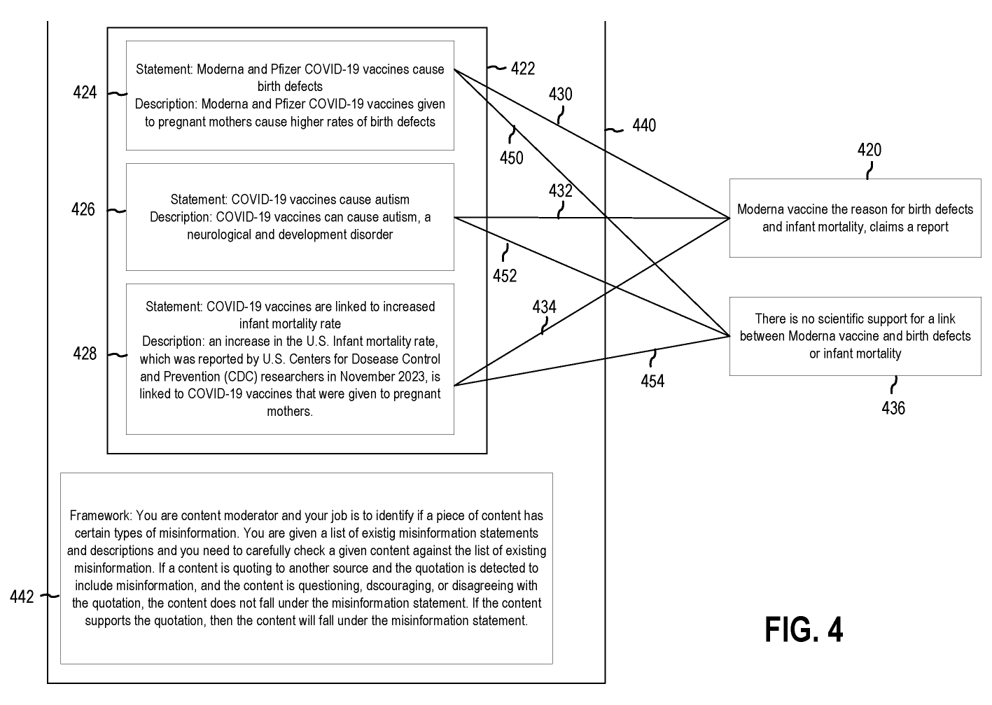

The adaptive misinformation detection system 100 may further include a prompt generator 106. The prompt generator 106 is configured to generate a dynamic prompt based on the set of misinformation. In some embodiments, the dynamic prompt is generated based on the set of misinformation and the content. The dynamic prompt includes the set of misinformation. In some embodiments, the dynamic prompt includes the set of misinformation and a framework. For example, the framework may provide additional instructions on how to detect similarities between the set of misinformation and the content. Additional examples are provided in connection to FIG. 4.

The adaptive misinformation detection system 100 further includes a model 108. In some embodiments, the model 108 is a generative pre-trained transformer (GPT) model. In some embodiments, the model 108 is a large language model (LLM). In some embodiments, the model 108 is a small language model (SLM).

The model 108 is configured to detect a similarity between the content and the set of misinformation by applying the dynamic prompt generated by the prompt generator 106. In some embodiments, similarity is determined by identifying a similarity score. For example, the similarity score may be determined by comparing one or more (or each) pieces of misinformation from the set of misinformation to the content. In another example, the similarity score may be determined by comparing one or more (or each) pieces of misinformation from the set of misinformation to the content by utilizing the provided framework (e.g., the provided instructions on how to make the comparison).

In various cases, the similarity score may then be compared to a known threshold similarity score. For example, if a threshold similarity score is 0.85 and the identified similarity score is 0.9, then the conclusion is that the content and the misinformation statement are similar, and hence there is misinformation in the content. In another example, if a threshold similarity score is 0.85 and the identified similarity score is 0.8, then the conclusion is that the content and the misinformation statement are not similar, and hence the content does not include the analyzed misinformation.

In some embodiments, a similarity score may be calculated for one or more (or each) pieces of misinformation in the set of misinformation. In some embodiments, if the identified similarity score is greater than or equal to the threshold score, the content includes misinformation. In some embodiments, if the identified similarity score is lower than the threshold score, the content does not include misinformation. In some embodiments, a similarity score may be calculated for the whole set of misinformation.

In some embodiments, an action may be taken in response to concluding that the set of misinformation and the content are similar. In some instances, as action is taken based on an indication that that the content includes misinformation. In some embodiments, the adaptive misinformation detection system 200 provides an indication that the content includes misinformation in response to the request. In some embodiments, the response may be to remove all of the content, filtering out the misinformation from the content, marking the content as misinformation and/or providing it to a content moderator for further processing and/or decision making, reducing visibility of the content to users, other actions, or combinations thereof.

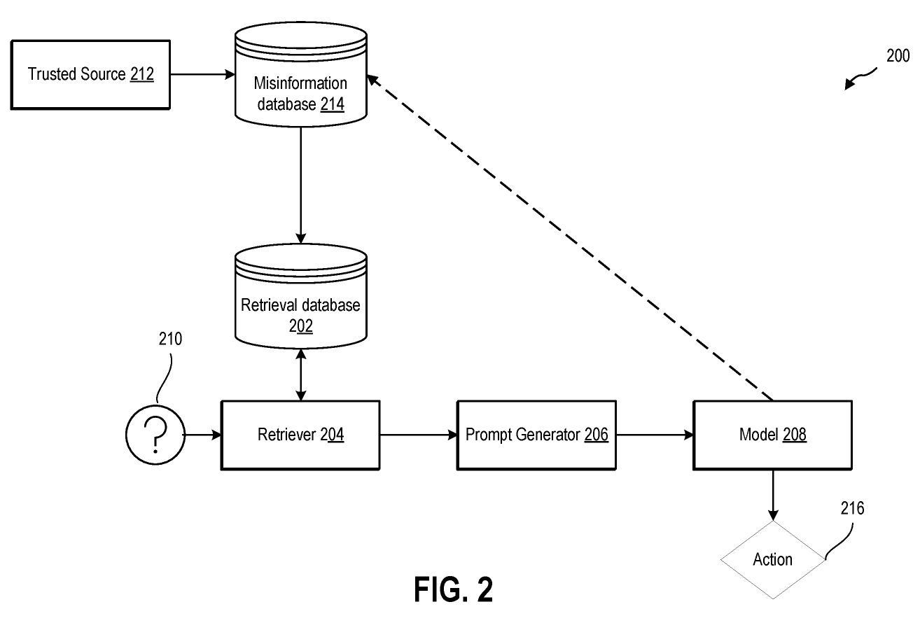

FIG. 2 illustrates an adaptive misinformation detection system 200 for identifying misinformation, in accordance with at least one embodiment. The adaptive misinformation detection system 200 may include a trusted source 212 for providing misinformation. In some embodiments, the trusted source 212 is an internal source, such as a DIRT source, content moderators who analyze, and/or identify statements that are misinformation. In some embodiments, the trusted source 212 is an outside source, such as a NEWSGUARD source or a FACTCHECK source, , other outside sources, or combinations thereof. The trusted source 212 may provide statements labeled as misinformation with or without a more detailed description about the statement or why the statement is labeled as misinformation.

In some embodiments, this misinformation provided by the trusted source 212 is stored on a misinformation database 214. The misinformation database 214 may store the misinformation in text form. In some embodiments, the misinformation database 214 may receive similar or even identical misinformation from one or more of the trusted sources 212. In some embodiments, the misinformation database 214 may choose to store all received misinformation as new misinformation, regardless of whether similar or identical misinformation is already stored by the misinformation database 214. In some embodiments, the misinformation database 214 may choose to reject identical misinformation already stored by the misinformation database 214 and store similar, but not identical, misinformation as a new entry in the misinformation database 214. In some embodiments, the misinformation database 214 may choose to reject similar or identical misinformation already stored by the misinformation database 214 and only store new misinformation. In some embodiments, the similar or identical misinformation may increment a rating of the misinformation.

In some embodiments, misinformation stored in the misinformation database 214 may be converted to an embedding (e.g., a vector embedding) and/or may be stored at a retrieval database 202. For example, the adaptive misinformation detection system 200 may use Ada-embedding to embed the misinformation into an embedding. Ada-embedding may encode the semantic statement and/or the misinformation statement. In another example, a BOW-embedding may encode a word occurrence in a statement. In some embodiments, both Ada-embedding and BOW-embedding may be used to convert misinformation from the misinformation database 214 into embeddings (e.g., vector embeddings) in the retrieval database 202. In some implementations, the retrieval database 202 includes both misinformation statements (and/or misinformation descriptions) and corresponding vector embeddings.

In some embodiments, the retrieval database 202 stores pieces of misinformation. For example, “Covid-19 is a hoax” may be a statement that is stored in the retrieval database 202 (e.g., in embedding form) as misinformation. In some embodiments, the retrieval database 202 stores pieces of misinformation (e.g., a plurality of misinformation statements and/or misinformation descriptions). For example, a statement of “COVID-19 vaccines caused excess deaths among millennials” may be followed by a more detailed description such as “U.S. Centers for Disease Control and Prevention (CDC) data shows excess deaths among millennials increased by 84 percent in 2021, coinciding with the rollout of COVID-19 vaccines and booster shots.”

In some embodiments, the retrieval database 202 stores and/or retrieves data using a hierarchical navigable small world (HNSW) method. HNSW may incrementally build a multi-layer structure consisting of hierarchical sets of proximity graphs (e.g., layers) for nested subsets of the stored data. In some embodiments, the retrieval database 202 stores and/or retrieves data using hierarchical clustering. Hierarchical clustering may group data points into a tree-like structure of clusters based on their similarity and/or distance. Typically, hierarchical clustering is a bottom-up approach where each item forms a cluster at the bottom, and these clusters may merge as the levels increase (e.g., from the bottom toward and/or to the top). The misinformation may be stored in the retrieval database 202 as vector embeddings to allow quick and easy search of similar data.

The adaptive misinformation detection system 200 further includes a retriever 204. The retriever 204 is configured to receive a request 210 to analyze content for misinformation. In some embodiments, the request is received from a search engine. For example, a search engine, when accessing a new website, may request that the adaptive misinformation detection system 200 analyze the content of the website for misinformation. One possible advantage of having the adaptive misinformation detection system 200 to analyze the content of the website for misinformation is that the search engine may use the information for classifying the website and/or to rank the website based on whether the content includes misinformation. For example, a search engine may choose not to include the website in a search result if the adaptive misinformation detection system 200 has concluded that it includes misinformation.

In some embodiments, the request is received from an AI assisted chat. For example, an AI assisted chat may generate a response to a request only based on content that has been deemed by the adaptive misinformation detection system 200 to not include misinformation. In some embodiments, the request is received from a content moderator. For example, a content moderator may request the adaptive misinformation detection system 200 to analyze a comment and/or a post made by a user on the content moderator’s platform. In some embodiments, the request is received from a licensed content provider. For example, a news platform that collects news from various sources may request the adaptive misinformation detection system 200 to analyze each news article it plans to provide through its news platform.

In some embodiments, the retriever 204 may retrieve a set of misinformation from the pieces of misinformation in the retrieval database 202. The retriever 204 may obtain an embedding for the content. For example, the retriever 204 may encode the received content to one or more vector embeddings. In some embodiments, the retriever 204 divides the content into smaller sections and/or identifies the most important (e.g., essential) information in each section to be embedded. In some embodiments, the retriever 204 limits the number of embeddings for the content to N number of embeddings for efficiency. For example, if more than twenty embeddings are generated from the content, the retriever 204 may only merge some of the embeddings together to keep the number of embeddings within the limit.

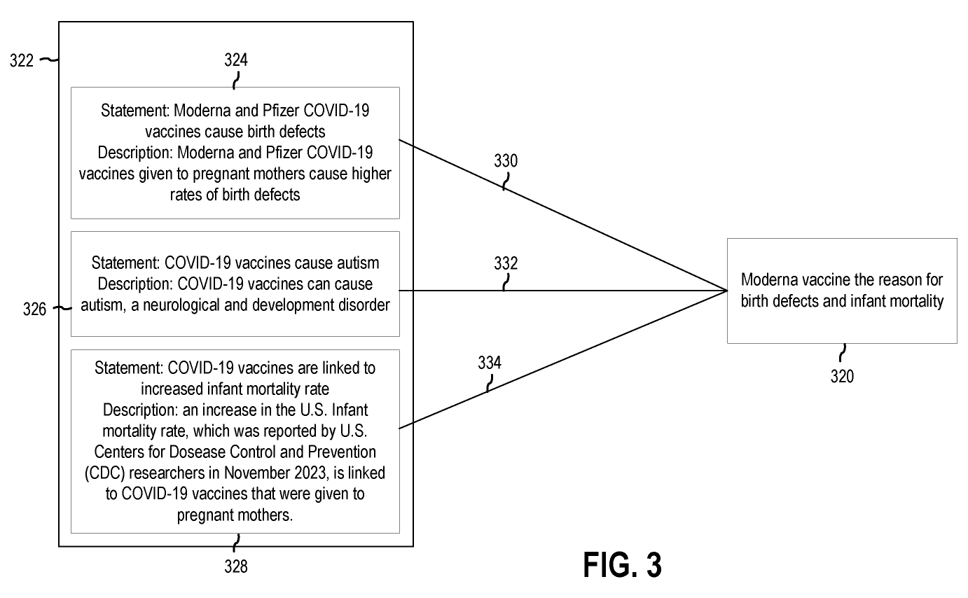

The retriever 204 may use the embedding to retrieve a set of misinformation from the retrieval database. In some embodiments, the similarity of the content embedding is compared to the similarity of misinformation stored in the retrieval database. For example, the retriever 204 may fetch the top K pieces of misinformation from the retrieval database 202 that are, for example, closest in the hierarchical space to the content embedding. In some embodiments, the number of pieces of misinformation fetched from the retrieval database 202 is limited for efficiency purposes. For example, the adaptive misinformation detection system 200 may limit the number (e.g., K) of pieces of misinformation fetched from the retrieval database 202 is twenty. An example of similarity analysis is further discussed in connection with FIG. 3.

The adaptive misinformation detection system 200 may further include a prompt generator 206. The prompt generator 206 may be configured to generate a dynamic prompt based on, for example, the set of misinformation and the content. The dynamic prompt may include the set of misinformation. In some embodiments, the dynamic prompt includes the set of misinformation, the content, and/or the framework. For example, the framework may provide additional instructions on how to detect similarities between the set of misinformation and the content. Additional examples are provided in connection to FIG. 4.

The adaptive misinformation detection system 200 further includes a model 208. In some embodiments, the model 208 is a generative pre-trained transformer (GPT) model. In some embodiments, the model 208 is a large language model (LLM). In some embodiments, the model 208 is a small language model (SLM). The model 208 is configured to detect a similarity between the content and the set of misinformation by applying the dynamic prompt generated by the prompt generator 206. In some embodiments, similarity is determined by identifying a similarity score. For example, similarity score may be determined by comparing each misinformation statement from the set of misinformation to the content. In another example, the similarity score may be determined by comparing one or more (or each) piece of misinformation from the set of misinformation to the content by utilizing the provided framework (e.g., the provided instructions on how to make the comparison). The similarity score may be compared to a known threshold similarity score. For example, if a threshold similarity score is 0.85 and the identified similarity score is 0.9, then the conclusion is that the content and the misinformation statement are similar, and hence there is misinformation in the content. In another example, if a threshold similarity score is 0.85 and the identified similarity score is 0.8, then the conclusion is that the content and the misinformation statement are not similar, and hence the content does not include the analyzed misinformation. In some embodiments, a similarity score may be calculated for each misinformation statement in the set of misinformation. In some embodiments, a similarity score may be calculated for the whole set of misinformation. In some embodiments, the model determines similarity scores in multiple classes and compares the similarity score of each class to the threshold similarity score to determine whether the content for a specific class and the misinformation statement are similar.

In some embodiments, an action 216 may be taken in response to concluding a similarity between the set of misinformation and the content. For example, the response may be to remove the whole content, filtering out the misinformation from the content, marking the content as misinformation and providing it to a content moderator for further processing and decision making, or reducing visibility of the content to users.

In some embodiments, when the content is concluded to include misinformation, the detected misinformation may be fed back to the misinformation database 214. The misinformation fed back to the misinformation database 214 may include different variation of the similar misinformation that is already included in misinformation database 214. One possible advantage of feeding back these different variations of the misinformation is that the adaptive misinformation detection system 200 may be able to make better decisions on similarity, as additional variations and additional details are provided relating to a misinformation already stored by the adaptive misinformation detection system 200. For example, the retriever 204 is able to make better decisions on similarity when provided with plurality of misinformation statement variations, or plurality of misinformation description variations. In some embodiments, subject matter experts first ensure that noisy or false positive statements are not added to a misinformation database that stores statements used for feedback.

FIG. 3 illustrates an example of detecting similarity between content and a set of misinformation. The content has been provided to the system, and the content has been analyzed and a content embedding 320 has been generated. For example, the system may divide the content into smaller sections (e.g., vectors) and identify the most important (e.g., essential) information on each section to be embedded. In some embodiments, the system will limit the number of embeddings for the content to N number of embeddings for efficiency purposes. For example, if more than 20 embeddings are generated from the content, the system may merge some of the embeddings together to keep the number of embeddings within the limit. For simplicity, the example shown in FIG. 3 includes only one content vector embedding 320.

The system uses the content embedding to retrieve a set of misinformation 322 from the retrieval database. As shown in FIG. 3, the system has retrieved a set of misinformation 322 including three separate misinformation statements with descriptions. These three misinformation statements (first misinformation statement 324, a second misinformation statement 326, and a third misinformation statement 328) are closest in the hierarchical space to the content vector embedding 320. The system may then compare the content vector embedding 320 to each of the misinformation in the set of misinformation 322 to detect similarity between the misinformation the content.

In the example shown in FIG. 3, the first misinformation statement 324 and the content 320 have received a first similarity score 330 of 0.94, the second misinformation statement 326 and the content 320 have received a second similarity score 332 of 0.45, and the third misinformation statement 328 and the content 320 have received a third similarity score 334 of 0.88. For example, the similarity score is calculated by a model, such as the model 208 in FIG. 2.

In the current example, a threshold of 0.85 has been set for similarity score. The first misinformation and the third misinformation have a similarity above 0.85 with the content, and thus the system concludes that the content includes misinformation. In some embodiments, the system may then feed back the first content 320 to a misinformation database and/or retrieval database. For example, if the system detects a variation of one or more misinformation statements already included in the misinformation database, the system may feed back the content 320 to be included in the misinformation database and/or retrieval database. One possible advantage of feeding back these different variations of the misinformation is that the adaptive misinformation detection system may be able to make better decisions on similarity, as additional variations and additional details are provided relating to a misinformation already stored by the system.

FIG. 4 illustrates an example of detecting similarity between content and a set of misinformation based on a prompt. Content has been provided to the system, the content has been analyzed, and two content embeddings (first content embedding 420, and a second content embedding 436) has been generated. For example, the system may divide the content into smaller sections and identify the most important (e.g., essential) information on each section to be embedded. In some embodiments, the system will limit the number of embeddings for the content to N number of embeddings for efficiency purposes. For example, if more than 20 embeddings are generated from content, the system may select the top 20 and disregard the remaining ones to keep the number of embeddings within the limit. For simplicity, the example shown in FIG. 4 includes only two content embeddings. In some embodiments, one or more content embeddings may include one or more content vector embeddings.

The system uses the content embedding to retrieve a set of misinformation 422 from the retrieval database. As shown in FIG. 4, the system has retrieved a set of misinformation 422 including three separate misinformation statements with descriptions. These three misinformation statements (first statement 424, a second statement 426, and a third statement 428) are closest in the hierarchical space to the first and second content embeddings (420 and 436). The system is also provided with a prompt 440. The prompt includes the set of misinformation 422 and may have been generated based on the set of misinformation 422. In addition, the prompt 440 includes a framework 442, shown as a non-limiting example. The framework 442 provides additional instructions to the system on how to detect similarities between the set of misinformation and the content.

As shown, the framework 442 in FIG. 4 provides additional instructions to the system for analyzing similarity between content and the misinformation. In particular, the framework 442 in FIG. 4 provides that a merely quoting a second source does not automatically mean that the requested content is misinformation. In particular, framework provides instructions that if the quotation is misinformation, but the content in general discourages, questions, or disagrees with the quoted content, that the content is not misinformation per se. If the content supports and/or agrees with the quoted misinformation, then the content is misinformation as well.

The system may then compare the first content embedding 420, and the second content embedding 436 to each of the misinformation in the set of misinformation 422 to detect similarity between the misinformation the content. In the example shown in FIG. 4, the first misinformation 424 and the first content 420 have received a first similarity score 430 of 0.24, the second misinformation 426 and the first content 420 have received a second similarity score 432 of 0.05, and the third misinformation 428 and the first content 420 have received a third similarity score 434 of 0.29. Similarly, the first misinformation 424 and the second content 436 have received a first similarity score 450 of 0.24, the second misinformation 426 and the second content 436 have received a second similarity score 452 of 0.05, and the third misinformation 428 and the second content 436 have received a third similarity score 454 of 0.27. For example, the similarity score is calculated by a model, such as the model 208 in FIG. 2. Utilizing a threshold of 0.85 for similarity score, the system concludes that the content does not include misinformation.

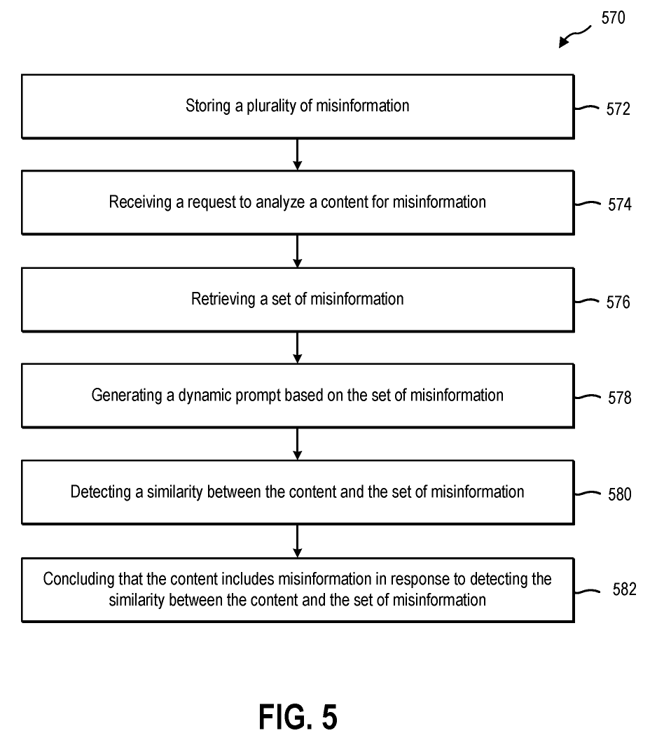

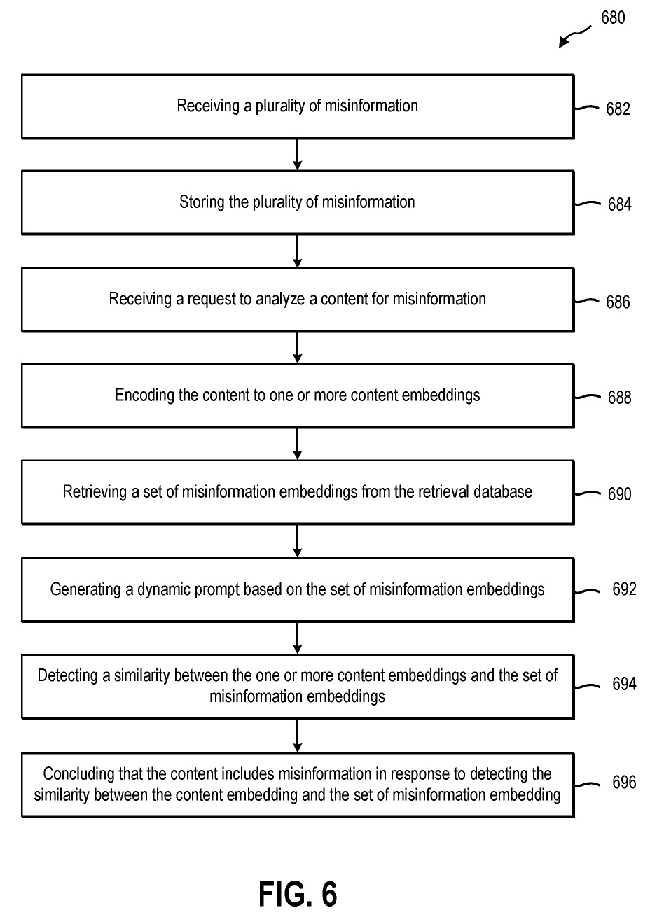

Turning now to FIGS. 5–6, each of these figures illustrate an example series of acts of a computer-implemented method for detecting misinformation according to one or more embodiments. While these figures illustrate acts according to one or more embodiments, alternative embodiments may omit, add to, reorder, and/or modify any of the acts shown.

The acts in FIGS. 5–6 can be performed as part of a method (e.g., a computer-implemented method). Alternatively, a computer-readable medium can include instructions that, when executed by a processing system with a processor, cause a computing device to perform the acts in FIGS. 5–6. In some implementations, a system (e.g., a processing system comprising a processor) can perform the acts in FIGS. 5–6. For example, the system includes a processing system and a computer memory including instructions that, when executed by the processing system, cause the system to perform various actions or steps.

As shown, FIG. 5 includes a series of acts 570. For example, the series of acts 570 includes act 572 of storing pieces of misinformation. For example, the pieces of misinformation may be stored in a retrieval database.

As further shown, the series of acts 570 include act 574 of receiving a request to analyze content for misinformation. For example, the request is received from one or more of an AI assisted chat, a search engine, a content moderator, or a licensed content provider.

As further shown, the series of acts 570 include act 576 of retrieving a set of misinformation. For example, the set of misinformation may be retrieved from a retrieval database, and there the set of misinformation relates to the content, and the set of misinformation is part of the pieces of misinformation..

As further shown, the series of acts 570 include act 578 of generating a dynamic prompt based on the set of misinformation. For example, the dynamic prompt includes the set of misinformation.

As further shown, the series of acts 570 include act 580 of detecting a similarity between the content and the set of misinformation. For example, the similarity between the content and the set of misinformation is detected by applying the dynamic prompt.

As further shown, the series of acts 570 include act 582 of concluding that the content includes misinformation in response to detecting the similarity between the content and the set of misinformation. For example, an action can be taken in response to concluding that the content includes misinformation.

As shown, FIG. 6 includes a series of acts 680. For example, the series of acts 680 includes act 682 of receiving pieces of misinformation. For example, the pieces of misinformation may be received from a trusted source and stored in a retrieval database.

As further shown, the series of acts 680 include act 684 of storing the pieces of misinformation. For example, the pieces of misinformation may be stored in a retrieval database as misinformation embeddings.

As further shown, the series of acts 680 include act 686 of receiving a request to analyze content for misinformation. For example, the request is received from one or more of an AI assisted chat, a search engine, a content moderator, or a licensed content provider.

As further shown, the series of acts 680 include act 688 of encoding the content to one or more content embeddings. For example, the one or more content embeddings may use Ada-embeddings (e.g., text-embedding-ada-002) and/or Bag Of Word embedding (BOW embedding).

As further shown, the series of acts 680 include act 690 of retrieving a set of misinformation embeddings from the retrieval database. For example, the set of misinformation embeddings may relate to the one or more content embeddings, and the set of misinformation embeddings may be part of the plurality of misinformation embeddings. As noted above, in some embodiments, the retrieval will occur based on an embedding vector. For example, statements are stored based on vector embeddings, and the content in question will be encoded into a vector embedding using the same approach, then we retrieve a set of misinformation from the retrieval database based on the vector embeddings.

As further shown, the series of acts 680 include act 692 of generating a dynamic prompt based on the set of misinformation embeddings. For example, the dynamic prompt may include the set of misinformation and a framework.

As further shown, the series of acts 680 include act 694 of detecting a similarity between the one or more content embeddings and the set of misinformation embeddings. For example, detecting a similarity between the one or more content embeddings and the set of misinformation embeddings is performed by applying the dynamic prompt.

As further shown, the series of acts 680 include act 696 of concluding that the content includes misinformation in response to detecting the similarity between the content embedding and the set of misinformation embedding. For example, an action can be taken in response to concluding that the content includes misinformation.

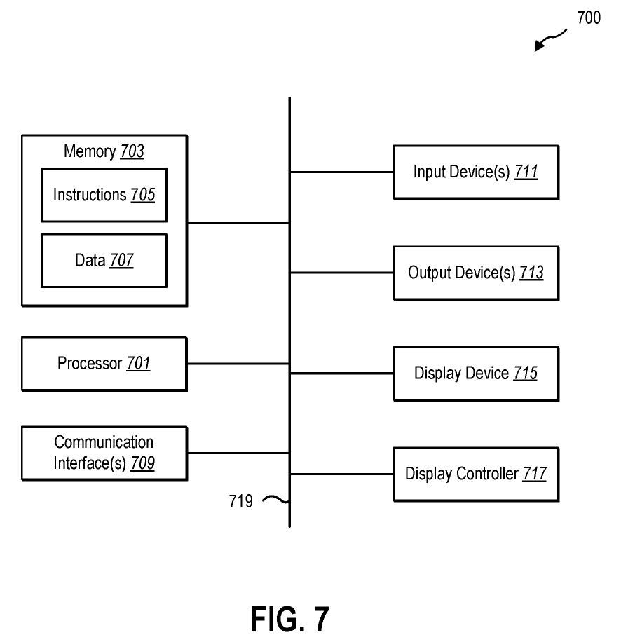

FIG. 7 illustrates certain components that may be included within a computer system 700, such as the misinformation system as described in connection to any of the previous figures. The computer system 700 may be used to implement the various computing devices, components, and systems described herein. As used herein, a “computing device” refers to electronic components that perform a set of operations based on a set of programmed instructions. Computing devices include groups of electronic components, client devices, server devices, etc.

In various implementations, the computer system 700 represents one or more of the client devices, server devices, or other computing devices described above. For example, the computer system 700 may refer to various types of network devices capable of accessing data on a network, a cloud computing system, or another system. For instance, a client device may refer to a mobile device such as a mobile telephone, a smartphone, a personal digital assistant (PDA), a tablet, a laptop, a wearable computing device (e.g., a headset or smartwatch), or exercise device. A client device may also refer to a non-mobile device such as a desktop computer, a server node (e.g., from another cloud computing system), or another non-portable device.

The computer system 700 includes a processing system including a processor 701. The processor 701 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 701 may be referred to as a central processing unit (CPU). Although the processor 701 shown is just a single processor in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof. In some embodiments, the memory 703 is non-transitory memory.

The instructions 705 and the data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during the execution of the instructions 705 by the processor 701.

A computer system 700 may also include one or more communication interface(s) 709 for communicating with other electronic devices. The one or more communication interface(s) 709 may be based on wired communication technology, wireless communication technology, or both. Some examples of the one or more communication interface(s) 709 include a Universal Serial Bus (USB), an Ethernet adapter, a wireless adapter that operates in accordance with an Institute of Electrical and Electronics Engineers (IEEE) 1002.11 wireless communication protocol, a Bluetooth® wireless communication adapter, and an infrared (IR) communication port.

A computer system 700 may also include one or more input device(s) 711 and one or more output device(s) 713. Some examples of the one or more input device(s) 711 include a keyboard, mouse, microphone, remote control device, button, joystick, trackball, touchpad, and light pen. Some examples of the one or more output device(s) 713 include a speaker and a printer. A specific type of output device that is typically included in a computer system 700 is a display device 715. The display device 715 used with implementations disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For clarity, the various buses are illustrated in FIG. 7 as a bus system 719.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A computer-implemented method for detecting misinformation, comprising:
receiving a request to analyze content for misinformation;
retrieving a set of misinformation that relates to the content by analyzing features of the content to identify misinformation with similar features;
generating a dynamic prompt that includes the content and the set of misinformation;
in response to providing the dynamic prompt to a generative artificial intelligence (AI) model, receiving a similarity score indicating a similarity between the content and the set of misinformation; and
based on using the similarity score to determine that the content includes misinformation, providing an indication that the content includes misinformation in response to the request.

2. The computer-implemented method of claim 1, further comprising:
storing pieces of misinformation having misinformation statements or misinformation descriptions in a misinformation database;
generating vector embeddings for the pieces of misinformation to encode the misinformation statements or the misinformation descriptions; and
storing the vector embeddings of the pieces of misinformation in a retrieval database, wherein the set of misinformation is retrieved using the retrieval database.

3. The computer-implemented method of claim 2, wherein the misinformation database includes misinformation provided by a trusted source.

4. The computer-implemented method of claim 1, wherein:
the content is included in a website; and
providing the indication that the content includes misinformation comprises omitting the website from a set of search results.

5. The computer-implemented method of claim 1, wherein:
the content is included in a response from an AI assisted chat; and
providing the indication that the content includes misinformation comprises omitting the content from a response of the AI assisted chat.

6. The computer-implemented method of claim 1, further comprises retrieving the set of misinformation from a retrieval database using hierarchical clustering.

7. The computer-implemented method of claim 1, further comprising:
generating a content embedding for the content based on receiving the request; and
identifying the set of misinformation based on comparing the content embedding to embeddings in a retrieval database.

8. The computer-implemented method of claim 7, wherein identifying the set of misinformation includes identifying k nearest neighbors of embeddings to the content embedding within in the retrieval database.

9. The computer-implemented method of claim 1, wherein the dynamic prompt further includes a framework that comprises instructions on how to determine the similarity score.

10. The computer-implemented method of claim 9, wherein the instructions on how to determine the similarity score include determining similarities between the content and statements associated with the set of misinformation.

11. The computer-implemented method of claim 10, wherein the instructions on how to determine the similarity further include determining the similarity score between the content and the set of misinformation based on the similarities.

12. The computer-implemented method of claim 11, further comprising:
comparing the similarity score for the content to a threshold similarity score; and
determining that the content includes misinformation based on the similarity score being equal to or greater than the threshold similarity score.

13. The computer-implemented method of claim 1, further comprising performing an action in response to determining that the content includes misinformation.

14. The computer-implemented method of claim 13, wherein the action includes reducing visibility of the content, removing the content, or filtering out a part of the content.

15. The computer-implemented method of claim 13, wherein the action includes storing the content as misinformation in a misinformation database as a statement and in a retrieval database as an embedding.

16. The computer-implemented method of claim 1, wherein the request is received from one or more of an artificial intelligence (AI) assisted chat, a search engine, a content moderator, or a licensed content provider.

17. A computer-implemented method for detecting misinformation, comprising:
receiving a request to analyze content for misinformation;
encoding the content to one or more content embeddings;
retrieving a set of misinformation embeddings that are similar to the one or more content embeddings from a retrieval database;
generating a dynamic prompt based on the set of misinformation embeddings that includes the content and instructions on how to determine a similarity score;
in response to providing the dynamic prompt to a generative artificial intelligence (AI) model, receiving the similarity score indicating a similarity between the content and the set of misinformation embeddings; and
determining that the content includes misinformation based on the similarity score for the content.

18. The computer-implemented method of claim 17, wherein the instructions on how to determine the similarity score include:
determining similarities between the content and statements associated with the set of misinformation embeddings; and
determine the similarity score between the content and the set of misinformation embeddings based on the similarities.

19. The computer-implemented method of claim 17, further comprising performing an action in response to determining that the content includes misinformation, wherein the action includes reducing visibility of the content, removing the content, or filtering out a part of the content.

20. A system comprising:
a processing system having a processor; and
a computer memory including instructions that, when executed by the processing system, cause the system to carry out operations comprising:
receiving a request to analyze content for misinformation;
retrieving a set of misinformation that relates to the content by analyzing features of the content to identify misinformation with similar features;
generating a dynamic prompt that includes the content and the set of misinformation;
in response to providing the dynamic prompt to a generative artificial intelligence (AI) model, receiving a similarity score indicating a similarity between the content and the set of misinformation; and
based on using the similarity score to determine that the content includes misinformation, providing an indication that the content includes misinformation in response to the request.
